(19) United States
(12) Patent Application Publication
(10) Pub. No.: US 2009/0056831 A1
(43) Pub. Date: Mar. 5, 2009

(54) FUEL DISPENSING NOZZLE INHIBITOR

(75) Inventor: Maurice Journee, Reilly (FR)

Correspondence Address: Solvay;c/o B. Ortego - IAM-NAFTA, 3333 Richmond Avenue, Houston, TX, 77098-3099, US

(73) Assignee: INERGY AUTOMOTIVE SYSTEMS RESEARCH (Societe Anonyme), Brussels (BE)

(21) Appl. No.: 12/281,776

(22) PCT Filed: Mar. 13, 2007
(86) PCT No.: PCT/EP2007/052356

§ 371 Date: Sep. 11, 2008

(30) Foreign Application Priority Data
Mar. 15, 2006 (FR) 06/02265
Aug. 11, 2006 (FR) 06/07315

(51) Int. Cl. B60K 15/04

(52) U.S. Cl. 141/350

(57) ABSTRACT

Safety system for a filter pipe for filling a tank, in particular a fuel tank, the filler pipe including a pipe head suitable for receiving a delivery nozzle, the system including a valve which is mounted in the pipe head and is able to swing, between closed and open positions, about a swing axis essentially tangential to the periphery of the valve. The valve is kept closed outside the filling periods by a prestressing means and is swung open by a force exerted by a free end of the delivery nozzle against a contact face of the valve during the nozzle insertion into the filler pipe. In some embodiments, the valve is for closing off tightly a capless filler pipe, and includes, on its contact face, a stop device designed to allow the insertion of a suitable delivery nozzle into the filler pipe, and not of an unsuitable nozzle.

### CROSS-REFERENCE TO RELATED APPLICATIONS

This application is a U.S. national stage application under 35 U.S.C. §371 of International Application No. PCT/EP2007/052356, filed Mar. 13, 2007, which claims priority to French Application No. 06.02265 filed Mar. 15, 2006, and to French Application No. 06.07315, filed Aug. 11, 2006, all of these applications being herein incorporated by reference in their entirety for all purposes.

### FIELD OF THE INVENTION

The present invention relates to a safety system for a filler pipe, for filling a tank, in particular a fuel tank. The invention relates especially to a safety system for preventing the insertion of an unsuitable delivery nozzle into the filler pipe.

### BACKGROUND OF THE INVENTION

In a motor vehicle, the fuel used to operate the engine is, in most cases, petrol or diesel. The use of a fuel unsuitable for the engine generally has an undesirable, or even disastrous, effect on the engine. When filling the tank with fuel, the user or the official of a service station must choose the correct pump. A filling error quickly arises and may for example be caused by a lack of knowledge of the vehicle in question or by lack of attention. This risk is higher if the user is not the regular user of the vehicle, for example in the case of hire cars.

To prevent diesel from being poured into a petrol tank, motor vehicle manufacturers and fuel distributors follow an international SAE standard whereby lead-free petrol delivery nozzles have a smaller diameter than the nozzle for delivering other fuels. According to this standard, lead-free petrol delivery nozzles must have a diameter between 20.5 mm and 21.3 mm and nozzles for delivering other fuels must have a diameter greater than 23.6 mm. The filler pipes for diesel and petrol tanks have diameters suitable for the respective delivery nozzle. Thus, diesel delivery nozzles, which have a larger diameter than the filler pipes of petrol tanks, cannot be inserted into the filler pipe of a petrol tank. Diesel therefore cannot be inadvertently poured into a petrol tank. However, the contrary is not true. Currently, there are no systems for preventing a diesel tank from being filled with petrol.

In the past, filler pipes were kept closed outside the filling periods, by caps on the external end of the filler pipe. In the event of such a cap being lost, the passage between the fuel tank and atmosphere remains open and contamination of the atmosphere by liquid fuel or fuel vapour cannot be avoided. For the purpose of preventing such contamination, it has been proposed to replace this cap with a closure valve inside the filler pipe, so as to get a capless filler pipe. Such a closure valve is generally kept in the closed position by a prestressing means, generally a spring. When a delivery nozzle is inserted into the filler pipe, the free end of the nozzle bears against the closure valve and swings it into the open position. Such a closure valve closes off tightly the capless filler pipe and it does prevent contamination of the atmosphere by liquid fuel or fuel vapour. However, such a closure valve does not prevent petrol from being poured into a diesel tank.

### SUMMARY OF THE INVENTION

The object of the present invention is to propose an improved safety system for a capless filler pipe, allowing the insertion of an unsuitable delivery nozzle into said filler pipe to be checked. In particular, the object of the present invention is to provide a safety system for a filler pipe that prevents the insertion of a petrol delivery nozzle into the filler pipe of a diesel tank. This objective is achieved by a safety system according to claim 1.

In accordance with the invention, what is proposed is a safety system for a capless filler pipe for filling a tank, in particular a fuel tank, the filler pipe including a pipe head suitable for receiving a delivery nozzle, the system including a valve mounted in the tank filler pipe head, in which system the valve is mounted so as to be able to swing about a swing axis between a closed position and an open position, the swing axis being essentially tangential to the periphery of the valve. The valve being kept in its closed position outside the filling periods by a prestressing means and being swung into its open position by a force exerted by a free end of a delivery nozzle against a contact face of the valve during insertion of the delivery nozzle into the filler pipe. The valve is kept in its closed position outside the filling periods by a prestressing means and is swung into its open position by a force exerted, during insertion of the delivery nozzle into the filler pipe, by a free end of a delivery nozzle against a contact face of the valve. According to another aspect of the present invention, the valve is a valve for closing off tightly the capless filler pipe and it and includes a stop device on its contact face, the stop device being designed so as to allow the insertion only of a suitable delivery nozzle into the filler pipe, preventing the insertion of an unsuitable delivery nozzle.

When an unsuitable delivery nozzle is inserted into the filler pipe, the valve mounted in the head of the filler pipe prevents the insertion of the unsuitable delivery nozzle by interaction of the stop device with the free end of the delivery nozzle. This interaction stops the valve from swinging into its open position and prevents the delivery nozzle from being inserted into the filler pipe.

When inserting a suitable delivery nozzle, there is no interaction between the stop device and the free end of the delivery nozzle. The latter can be inserted further into the filler pipe, by the valve swinging into its open position.

Such a safety system consequently prevents the valve from opening when an unsuitable delivery nozzle is inserted. Non-conforming filling of the tank can therefore be avoided.

If an unsuitable delivery nozzle is inserted into the pipe, it may happen that the supply of fuel is initiated even though the delivery nozzle has not been able to be inserted into the filler pipe. This situation could occur if a user wishes to try filling up with fuel.

In this case, a particular embodiment may be provided in which the valve includes a deflector capable of dispersing a fuel jet emitted by the delivery nozzle and of tripping the automatic cut-off in the supply of fuel by the nozzle.

In general the deflector includes a surface designed to create turbulence in the fuel if a filling attempt is made while the nozzle is blocked by the stop device and not engaged in the pipe.

Now, in general, the nozzle includes a device for automatically stopping the supply of fuel. When the fuel jet is dispersed by the deflector, the deflector acts on this device, thus immediately stopping the supply of fuel. The deflector thus makes it possible to stop the supply of fuel in the event of inopportune actuation.

The prestressing element is preferably a spring. However, it is not excluded to use any other mechanical device for keeping the valve in its closed position outside the filling periods.

Preferably, the unsuitable delivery nozzle has an outside diameter smaller than a predetermined threshold diameter; and the suitable delivery nozzle has an outside diameter greater than the predetermined threshold diameter. Within the context of petrol delivery nozzles and diesel delivery nozzles, this predetermined threshold is preferably 22.5 mm, thus preventing the insertion of nozzles with a diameter of less than 22.5 mm, such as petrol delivery nozzles that have a nominal diameter of 20.6 mm. The insertion of nozzles with a diameter greater than 22.5 mm, such as diesel delivery nozzles that have a nominal diameter of 23.8 mm, is however not prevented.

The tank may be a fuel tank and the predetermined threshold diameter may be appreciably smaller than the diameter of a diesel delivery nozzle. The unsuitable delivery nozzle may then be a petrol delivery nozzle and the suitable delivery nozzle may be a diesel delivery nozzle. The insertion of a diesel delivery nozzle into the filler pipe of a petrol tank may consequently be avoided by configuring the pipe with a smaller diameter. The insertion of a petrol delivery nozzle into the filler pipe of a diesel tank may, in contrast, be avoided by the safety system according to the invention.

According to a first embodiment of the invention, the contact face of the valve is designed so as to form a guiding groove extending essentially perpendicular to the swing axis of the valve. The guiding groove is designed so as to receive and guide the delivery nozzle towards the inside of the filler pipe. The guiding groove is dimensioned so as to receive, on its bottom, the free end of an unsuitable delivery nozzle and to receive, at a predetermined distance from the bottom, the free end of a suitable delivery nozzle. According to one important aspect of the invention, the stop device comprises a stop catch placed at the bottom of the guiding groove and having a height lower than the predetermined distance.

When an unsuitable delivery nozzle is inserted, for example a petrol delivery nozzle inserted into the filler pipe of a diesel tank, the free end of the petrol delivery nozzle is received in the bottom of the guiding groove and is guided towards the stop catch. When the free end of the petrol delivery nozzle comes into contact with the stop catch, the insertion of the petrol delivery nozzle into the filler pipe and the swinging of the valve into its open position are prevented. Thanks to the safety system according to the first embodiment of the invention, it is consequently not possible to insert a petrol delivery nozzle into the filler pipe of a diesel tank.

In contrast, when a suitable delivery nozzle is inserted, for example a diesel delivery nozzle inserted into the filler pipe of a diesel tank, the free end of the diesel delivery nozzle is also received in the guiding groove, but it is not received, thanks to its larger diameter, in the bottom of the guiding groove. By inserting the diesel delivery nozzle, its free end is guided towards but does not come into contact with, the stop catch placed in the bottom of the groove. This is because the free end of the diesel delivery nozzle is guided to a predetermined distance from the bottom of the groove. Since the stop catch has a height of less than the predetermined distance, the free end of the diesel delivery nozzle passes over the top of the stop catch. The insertion of the diesel delivery nozzle and the swinging of the valve into its open position are not impeded by the stop device. Consequently, it is possible to insert a diesel delivery nozzle into the filler pipe of a diesel tank.

To summarize, when the filler pipe head of a diesel tank is provided with a safety system according to the first embodiment of the invention, this system allows a diesel delivery nozzle to be inserted but prevents the insertion of a petrol delivery nozzle.

Preferably, the stop catch is formed as a single part with the valve.

The valve and the stop catch may also be formed by several elements, possibly made of different material. Thus, plastics and metals may be combined to obtain a compromise between the need to limit weight and the need to provide a valve of good strength and good wear resistance.

According to a second embodiment of the invention, the contact face of the valve includes a stop device with a projection extending radially between the swing axis and the centre of the valve, the projection being designed so as to come into contact with the free end of the delivery nozzle. The projection comprises a recess dividing the projection radially into a first portion and a second portion, the recess being dimensioned and designed so as to receive the free end of an unsuitable delivery nozzle, the second portion serving as a stop catch for an unsuitable delivery nozzle, and the first portion serving as a guide for bringing a suitable delivery nozzle above the second portion.

When an unsuitable delivery nozzle is inserted, for example a petrol delivery nozzle inserted into the filler pipe of a diesel tank, the free end of the petrol delivery nozzle is received in the recess of the projection, between the first and second portions. When the nozzle is inserted further into the pipe, the swinging of the valve allows the free end of the nozzle to come into contact with the second portion of the projection, which therefore acts as a stop catch and prevents the insertion of the petrol delivery nozzle into the filler pipe and prevents the valve from swinging into its open position. Thanks to the safety system according to the second embodiment of the invention, it is consequently impossible to insert a petrol delivery nozzle into the filler pipe of a diesel tank.

In contrast, when a suitable delivery nozzle is inserted, for example a diesel delivery nozzle inserted into the filler pipe of a diesel tank, the free end of the diesel delivery nozzle is received on the first portion of the projection. When the nozzle is inserted further into the pipe, the swinging of the valve allows the free end of the nozzle to slide over the first portion of the projection towards the second portion of the projection. The second portion of the projection is configured so that, when the valve makes an angle in which the free end of the nozzle reaches the height of the recess, the free end of the nozzle passes over the top of the recess and the second portion of the projection. In the case of a diesel delivery nozzle, the second portion of the projection therefore does not act as a stop catch and the insertion of the diesel delivery nozzle and the swinging of the valve into its open position are not impeded by the stop device. Consequently, it is possible to insert a diesel delivery nozzle into the filler pipe of a diesel tank.

To summarize, when the filler pipe head of a diesel tank is provided with a safety system according to the second embodiment of the invention, this system allows a diesel delivery nozzle to be inserted but prevents the petrol delivery nozzle being inserted.

Preferably, the projection is formed as a single part with the valve.

The valve and the projection may also be formed by several elements, possibly made of different material. Thus, plastics and metals may be combined to obtain a compromise between the need to limit weight and the need to provide a valve of good strength and good wear resistance.

It should be noted that according to the invention, the valve is the one closing off tightly the capless filler pipe head. Such a closure valve is configured so as to prevent in its closed position, liquid fuel or fuel vapour leaking into the atmosphere.

### BRIEF DESCRIPTION OF THE DRAWINGS

Other particular aspects and features of the invention will become apparent from the description of a few advantageous embodiments presented below, by way of illustration, with reference to the appended drawings. These show:

FIG. 1: a schematic view on the contact face of a valve according to the first embodiment of the invention;

FIG. 2: a schematic sectional view of the valve of FIG. 1;

FIG. 3: a schematic sectional view of a valve according to the second embodiment of the invention;

FIG. 4: a schematic sectional view of the valve of FIG. 3 during insertion of a petrol delivery nozzle; and

FIG. 5: a schematic sectional view of the valve of FIG. 3 during insertion of a diesel delivery nozzle.

### DETAILED DESCRIPTION OF THE INVENTION

In the figures, the same reference symbols denote identical elements.

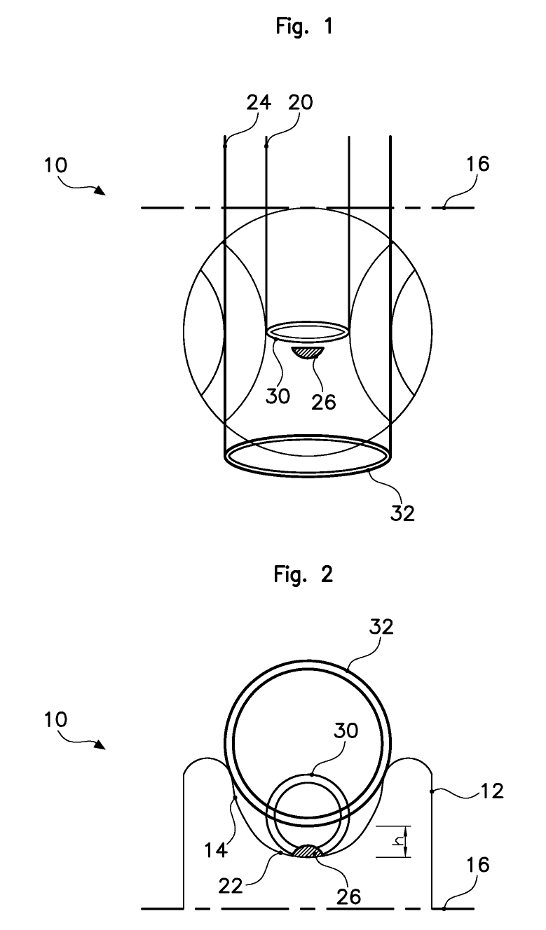

A first embodiment of a valve according to the invention is illustrated in FIGS. 1 and 2. Such a valve 10 includes a cover 12 with a guiding groove 14 extending essentially perpendicular to the swing axis 16 of the valve 10.

The guiding groove 14 is dimensioned so as to receive a petrol delivery nozzle 20 on its bottom 22 and to receive a diesel delivery nozzle 24 at a predetermined distance h from the bottom 22. A stop catch 26 having a height of less than the predetermined distance h is provided in the bottom 22 of the guiding groove 14 so that, when a petrol delivery nozzle 20 is inserted into a filler pipe head, the free end 30 of the petrol delivery nozzle 20 exerts a force on the valve 10 and makes it swing about the swing axis 16 into an open position. When the valve 10 has swung open, the free end 30 of the petrol delivery nozzle 20 is guided by the guiding groove 14. When the free end 30 of the petrol delivery nozzle 20, which is received on the bottom 22 of the guiding groove 14, comes into contact with the stop catch 26, the insertion of the petrol delivery nozzle 20 is prevented.

In contrast, when a diesel delivery nozzle 24 is inserted, the free end 32 of this nozzle 24 is also guided by the guiding groove 14. Thanks to its larger diameter, the free end 32 of the diesel delivery nozzle 24 is not received on the bottom 22 of the guiding groove 14 but is kept at a predetermined distance h from the bottom 22. Since the stop catch 26 has a height of less than the predetermined distance h, it is not an obstacle to the free end 32 of the diesel delivery nozzle 24 being advanced into the guiding groove 14. The free end 32 passes over the top of the stop catch 26 and swings the valve 22 into its open position, thus allowing the diesel delivery nozzle 24 to be fully inserted into the filler pipe of the diesel tank.

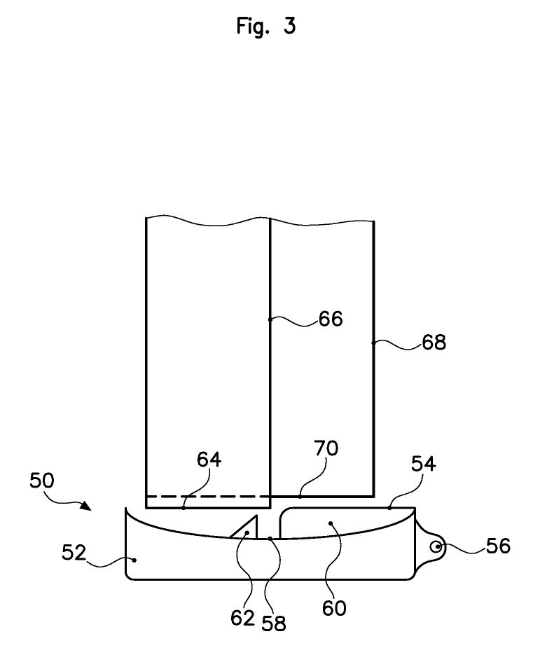

A second embodiment of a valve according to the invention is illustrated in FIGS. 3, 4 and 5. Such a valve 50 includes a cover 52 with a projection 54 extending radially between the swing axis 56 and the centre of the valve 50. The projection 54 includes a recess 58 dividing the projection radially into a first portion 60 and a second portion 62, preferably in the form of a triangle. The recess 58 is dimensioned and designed so as to receive the free end 64 of a petrol delivery nozzle 66.

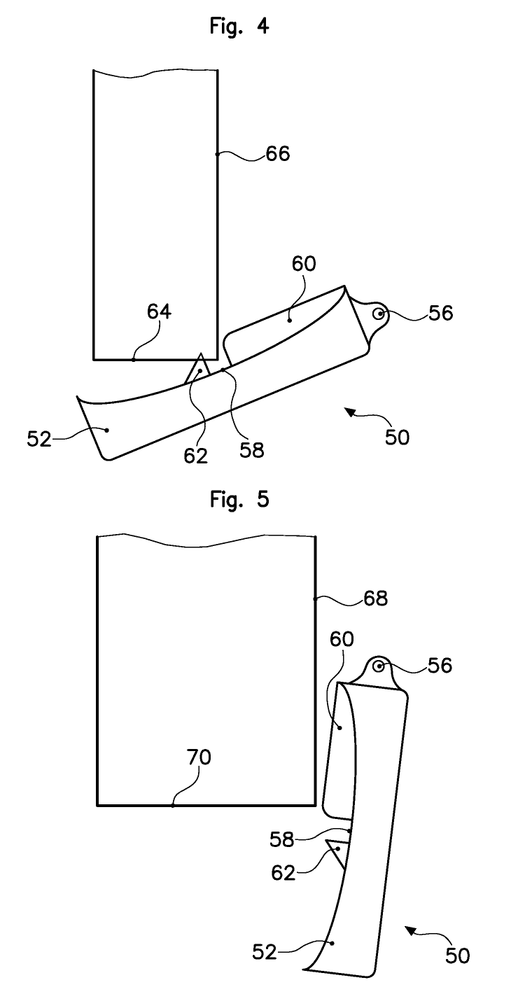

When a petrol delivery nozzle 66 is inserted, as illustrated in FIG. 4, the free end 64 is received in the recess 58 of the projection 54, between the first portion 60 and the second portion 62. When the nozzle 66 is inserted further into the pipe, the swinging of the valve 50 allows the free end 64 of the nozzle 66 to come into contact with the second portion 62, which then acts as a stop catch and prevents the petrol delivery nozzle 66 from being inserted into the filler pipe and prevents the valve 50 from swinging into its open position.

When a diesel delivery nozzle 68 is inserted, as illustrated in FIG. 5, the free end 70 of the diesel delivery nozzle 68 comes into contact with the first portion 60 of the projection 54. When the nozzle 68 is inserted further into the pipe, the swinging of the valve 50 allows the free end 70 of the nozzle 68 to approach the recess 58. When the valve 50 makes an angle in which the free end 70 of the nozzle 68 reaches the height of the recess 58, the second portion 62 of the projection 54 is no longer in the path of the nozzle 68 and can no longer serve as a stop catch. The insertion of the diesel delivery nozzle 68 and the swinging of the valve 50 into its open position are not impeded by the stop device.

Reference symbols

| | | | |
|---|---|---|---|
| 10 | Valve | 50 | Valve |
| 12 | Cover | 52 | Cover |
| 14 | Guiding groove | 54 | Projection |
| 16 | Swing axis | 56 | Swing axis |
| 20 | Petrol delivery nozzle | 58 | Recess |
| 22 | Bottom | 60 | First portion |
| 24 | Diesel delivery nozzle | 62 | Second portion |
| 26 | Stop catch | 64 | Free end of a petrol |
| | | | delivery nozzle |
| h | Predetermined distance | 66 | Petrol delivery nozzle |
| 30 | Free end of a petrol | 68 | Diesel delivery nozzle |
| | delivery nozzle | | |
| 32 | Free end of a diesel | 70 | Free end of a diesel |
| | delivery nozzle | | delivery nozzle |

1. A safety system for a filler pipe for filling a tank, in particular a fuel tank, the filler pipe including a pipe head suitable for receiving a delivery nozzle, the system including a valve mounted in the tank filler pipe head, in which system the valve is mounted so as to be able to swing about a swing axis between a closed position and an open position, the swing axis being essentially tangential to the periphery of the valve, the valve being kept in its closed position outside the filling periods by a prestressing means and being swung into its open position by a force exerted by a free end of a delivery nozzle against a contact face of the valve during insertion of the delivery nozzle into the filler pipe, wherein
the valve is a valve for closing off tightly a capless filler pipe and that said valve includes a stop device on its contact face, the stop device being designed so as to allow the insertion only of a suitable delivery nozzle into the filler pipe, preventing the insertion of an unsuitable delivery nozzle.

2. The safety system according to claim 1, wherein
the unsuitable delivery nozzle has an outside diameter smaller than a predetermined threshold diameter; and
the suitable delivery nozzle has an outside diameter greater than the predetermined threshold diameter.

3. The safety system according to claim 2, wherein the tank is a fuel tank and the predetermined threshold diameter is appreciably smaller than the diameter of a diesel delivery nozzle, the unsuitable delivery nozzle being a petrol delivery nozzle and the suitable delivery nozzle being a diesel delivery nozzle.

4. The safety system according to claim 2, wherein the contact face of the valve is designed so as to form a guiding groove extending essentially perpendicular to the swing axis of the valve, the guiding groove being designed so as to receive and guide the delivery nozzle towards the inside of the filler pipe, the guiding groove being dimensioned so as to receive, on its bottom, the free end of an unsuitable delivery nozzle and to receive, at a predetermined distance from the bottom, the free end of a suitable delivery nozzle, and the stop device comprising a stop catch placed at the bottom of the guiding groove and having a height lower than the predetermined distance.

5. The safety system according to claim 4, wherein the stop catch is formed as a single part with the valve.

6. The safety system according to claim 2, wherein the contact face of the valve includes a stop device with a projection extending radially between the swing axis and the centre of the valve, the projection being designed so as to come into contact with the free end of the delivery nozzle, the projection comprising a recess dividing the projection radially into a first portion and a second portion, the recess being dimensioned and designed so as to receive the free end of an unsuitable delivery nozzle, the second portion serving as a stop catch for an unsuitable delivery nozzle, and the first portion serving as a guide for bringing a suitable delivery nozzle above the second portion.

7. The safety system according to claim 6, wherein the projection is formed as a single part with the valve.

8. The safety system according to claim 1, wherein the valve includes a deflector capable of dispersing a fuel jet emitted by the delivery nozzle and of tripping the automatic cut-off in the supply of fuel by the nozzle.
